(19) United States
(12) Patent Application Publication
(10) Pub. No.: US 2013/0339460 A1
(43) Pub. Date: Dec. 19, 2013

(54) Protocol Expander System and Method

(71) Applicants: Roy Rim, Brooklyn, NY (US); John Viega, New York, NY (US); David Coffey, Hingham, MA (US)

(72) Inventors: Roy Rim, Brooklyn, NY (US); John Viega, New York, NY (US); David Coffey, Hingham, MA (US)

(21) Appl. No.: 13/920,071

(22) Filed: Jun. 17, 2013

Related U.S. Application Data
(60) Provisional application No. 61/660,454, filed on Jun. 15, 2012.

(51) Int. Cl. H04L 12/58

(52) U.S. Cl. CPC H04L 51/00
USPC 709/206

(57) ABSTRACT

A protocol expander system and method operable to provide expanded capabilities for handling of electronic communications and documents including, for instance, by expanding capabilities of email-access software by incorporating an expanded email protocol layer between an email client and one or more electronic communications and/or document services.

### CROSS-REFERENCE TO RELATED APPLICATION

This Patent Application claims priority to U.S. Provisional Patent Application Ser. No. 61/660,454 filed Jun. 15, 2012, and titled Protocol Expander, the entire contents of which is incorporated herein by reference in its entirety.

### BACKGROUND

1. Field

The present inventive concept pertains to a protocol expander. The present inventive concept more particularly concerns a protocol expander system and method for handling electronic media such as electronic communications and/or electronic documents.

2. Discussion of Related Art

An email client allows a user to access and manage a user's email. A protocol expander primarily deals with limitations of email clients. Common locally-installed email clients are provided under the trademarks MICROSOFT OUTLOOK® and MOZILLA® THUNDERBIRD®. A common web-based email client is provided under the trademark GMAIL®. Such traditional email clients have limitations on email storage as well as interaction with email and other electronic communications and documents. Further, many users prefer to view their email via an email client or a smart phone instead of via a website application, e.g., the default website application provided under the trademark GMAIL®.

Email clients are commonly used to view, send, and receive email messages. Email messages contain header and body information as well as certain flags for notifying the user regarding any read or un-read statuses. Email clients are also ideal for use in displaying a variety of formats for messages as well as displaying most image attachments. For any attachments that an email client cannot natively display, it will typically submit a request to the operating system running the email client to use the appropriate program to display attachments. Email clients also have a concept of folders so that users can organize their email messages into some logical order.

An example of new services that deal with electronic communication like email but provide no interaction with email clients are “archive services.” Archive services for electronic communications came about as a solution to solve large storage problems. These services usually keep copies of email separate from the original email service. This frees up the original email service to only retain a certain amount of messages that would be readily available to the users. These archive services provide a website for users and administrators to access those electronic communications and documents that are no longer on the original email service.

The problem with these services is that a user can typically only access the service through proprietary web site interfaces. This means users cannot access their entire archive of messages through their preferred email client, which would be the natural way to view the contents of email messages. Since they cannot use their preferred email client, they are forced to find and view messages through non-standard proprietary web based interfaces. These interfaces are also typically not optimized for viewing on smaller screens such as those on smart devices.

By way of example, certain services provide stubbing for accessing a large store of personal email. Stubbing is the practice of removing the complete email message, or an individual section of an email message, e.g., an attachment to the email, storing this data elsewhere, and substituting this removed section with meta-data consisting of where to locate the removed section. Stubbing is deficient when used with large sets of messages and it has an awkward mechanism for retrieving and viewing messages.

Another example of new services is compliance services. Email and other electronic messages used to carry on business communications have become a common mechanism for recording business transactions and agendas. Due to this, a number of compliance practices have arisen to account for or provide business guidelines on how to fit electronic messaging into the compliance and regulation space to which the business needs to adhere. Some examples of these areas of compliance are HIPAA, SEC, FINRA, and legal eDiscovery methodologies. Compliance services for electronic communications is a solution provided as a solution to resolve growing legal concerns over the use of email and other electronic communications and documents for personal and corporate use. Government regulations now require certain types of organizations to retain and review electronic communications and documents for compliance purposes. Even organizations that are not required to follow any government regulations will typically create or employ their own compliance service for internal auditing or other legal review processes. Like the archive services previously mentioned, compliance services retain copies of all electronic communications separate from the original email service and also provide access to those communications to an administrator or compliance review person through a website.

Other examples of new services are social media services such as those provided under the trademarks TWITTER® and FACEBOOK®. These services provide different electronic communications between their users via messages such as tweets, wall postings, chats internal to the service, and/or their own type of email. Organizations are also working to retain copies of all these communications from their users. Users can easily access these services through the service-respective websites or through applications tailored to provide these new services. However, there is no way for a user, an administrator, or a compliance-review person to access this information through an email client.

Despite email clients being a common method to view, send, and receive email, new services provided to handle email and other electronic communications and documents provide no true interaction with common email clients. Further, current email clients do not provide any capability to interact with other electronic documents or other services other than email.

Thus, there is a demand for a system and method configured to allow a user to access entire email archives and/or other similar data sets via their preferred email client and/or other electronic device, e.g., a smart phone provided under the trademarks IPHONE® or ANDROID®.

### SUMMARY

The present inventive concept described herein remedies the aforementioned problems by providing a unique system and method operable to XXXXXX.

The aforementioned may be achieved in an aspect of the present inventive concept by providing a method to provide control over a communication system, implemented at least in part by a computing device. The method may include the steps of creating one or more administrative folders, inserting at least one control message in the one or more administrative folders, determining if a user has a compliance role, allowing at least one compliance action to occur if the user is determined to have the compliance role, and/or facilitating at least one administrative action on a message in the communication system.

The communication may be an email communication. The at least one control message may be configured to cause at least one default action to occur on the one or more administrative folders. The compliance role determination may be performed during a login operation. The facilitating of the at least one administrative action on the message in the communication may be performed when the user issues a command to the computing device. The at least one administrative action may be a compliance action.

The aforementioned may be achieved in another aspect of the present inventive concept by providing a system to provide control over a communication. The system may include one or more administrative folders, at least one control message configured to be inserted in one or more of the administrative folders, and/or a processor configured to determine if a user has a compliance role. The processor may be configured to (i) allow at least one compliance action to occur if the user is determined to have the compliance role, and/or (ii) facilitate at least one administrative action on a message in the communication system.

Additional aspects, advantages, and utilities of the present inventive concept will be set forth in part in the description which follows and, in part, will be obvious from the description, or may be learned by practice of the present inventive concept.

The foregoing is intended to be illustrative and is not meant in a limiting sense. Many features and subcombinations of the present inventive concept may be made and will be readily evident upon a study of the following specification and accompanying drawings comprising a part thereof. These features and subcombinations may be employed without reference to other features and subcombinations.

### BRIEF DESCRIPTION OF THE DRAWINGS

The present inventive concept is described in detail below with reference to the attached drawing figures, wherein:

FIG. 1 is a diagram illustrating capabilities of a conventional email client with email services;

FIG. 2 is a diagram illustrating capabilities of an email client provided by the system and method of the present inventive concept;

FIG. 3 is a diagram illustrating folders provided by the system and method of the present inventive concept;

FIG. 4 is a flowchart illustrating an example usage of the system and method of the present inventive concept;

FIG. 5 is a flowchart illustrating an example usage of the system and method of the present inventive concept;

FIG. 6 is a flowchart illustrating an example usage of the system and method of the present inventive concept;

FIG. 7 is a flowchart illustrating an example usage of the system and method of the present inventive concept;

FIG. 8 is a flowchart illustrating an example usage of the system and method of the present inventive concept;

FIG. 9 is a flowchart illustrating importing messages.

The drawing figures do not limit the present inventive concept to the specific examples disclosed and described herein. The drawings are not necessarily to scale, emphasis instead being placed upon clearly illustrating the principles of the present inventive concept.

### DETAILED DESCRIPTION

The following detailed description references the accompanying drawings that illustrate the present inventive concept. The illustrations and description are intended to describe aspects of the present inventive concept in sufficient detail to enable those skilled in the art to practice the present inventive concept. Other components can be utilized and changes can be made without departing from the scope of the present inventive concept. The following detailed description is, therefore, not to be taken in a limiting sense. The scope of the present inventive concept is defined only by the appended claims, along with the full scope of equivalents to which such claims are entitled.

In this description, references to “one embodiment,” “an embodiment,” or “embodiments” mean that the feature or features being referred to are included in at least one embodiment of the present inventive concept. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present inventive concept can include a variety of combinations and/or integrations of the embodiments described herein.

The present inventive concept provides a system and method for a “protocol expander” or “email protocol expander” configured to expand functionality by increasing a number of available protocols available using one or more email clients. The system and method of the present inventive concept is configured to handle, e.g., display, electronic communications and/or documents outside or independent of traditional or regular email. For example, in an embodiment of the present inventive concept, the protocol expander is configured to expand on one or more protocols used by one or more email clients when communicating with a compliance service. In this manner, the protocol expander allows an administrator or compliance review person to monitor and access whether a system or compliance service is adhering to established compliance standards and/or monitor and view an organization's email through an email client.

The protocol expander of the present inventive concept is configured for use with common email client software by overriding supported communication methods already in use with one or more new folder definitions, flags and headers. In this manner, the protocol expander of the present inventive concept is operable to enhance and expand capabilities of traditional email client software. For certain scenarios, special messages and/or command messages can be used to provide one or more additional configuration controls to the user of the present inventive concept that are not provided to the user by traditional email clients. The protocol expander of the present inventive concept allows the user to use their preferred email client to interact with electronic communications and/or document services that would not be possible using just their preferred email client.

The protocol expander of the present inventive concept provides, among other things, a personal email archive of unlimited storage space. In this manner, the user may access email and/or electronic communications data from an alternative data store via a common email client. The user gains access to this data via their credentials, and is able to configure multiple devices to display the same data.

The protocol expander of the present inventive concept also provides the user with access to one or more other mailboxes of a single organization. In this manner, the user of the protocol expander is able to configure and control who can access the other email boxes and/or one or more specific subsets of the email boxes, and define how such access is granted to others. This can be used to increase collaboration, carry out necessary business functions, e.g., legal review, and/or be used for other needs, e.g., compliance oversight.

The protocol expander of the present inventive concept also provides access to administrative services. In this manner, the user can administer, control, and/or configure one or more services directly through their email client via control messages. These control messages are specially crafted email messages configured to cause specific functions to be performed on a server thereby allowing the user to easily carry out one or more administrative functions on the service.

The protocol expander of the present inventive concept provides access to compliance-type services. An organization may be required to perform one or more business functions on their employee emails. Such functions may include, for example, legal review and conversation oversight for regulatory purposes, e.g., such as to meet FINRA regulations. An embodiment of the present invention allows for these functions to be carried out through the email client for users that need to perform this functionality.

The protocol expander of the present inventive concept provides access to non-email related services. Specifically, alternative services, such as other digital communications media, e.g., social media or instant messages, may be accessed.

The protocol expander of the present inventive concept overcomes limitations of email clients when dealing with large sets of email. Email clients have intrinsic limitations when dealing with large sets of data either local to a machine that it operates on or on an email server. In an embodiment of the present inventive concept, these limitations are overcome by allowing the client to interact with the service in an intuitive fashion via control messages. These control messages are specially crafted email messages by the user using the system and method of the present inventive concept that cause commands to be performed, as defined or detailed by the user.

The protocol expander of the present inventive concept is configured to provide and utilize one or more folders to display to the user logical separation between their current email and other services available through the protocol expander. Folders of the protocol expander may include, but are not limited to, an archive of unlimited email history, search history and messages in search, IM conversations, other electronic documents such as those produced using software made available under the trademarks MICROSOFT WORD®, MICROSOFT EXCEL®, and/or the like, access to social media and other types of services, review folder for compliance, assignments folder for assigning messages to others, statistics and reports folder, and/or messages from one or more other users.

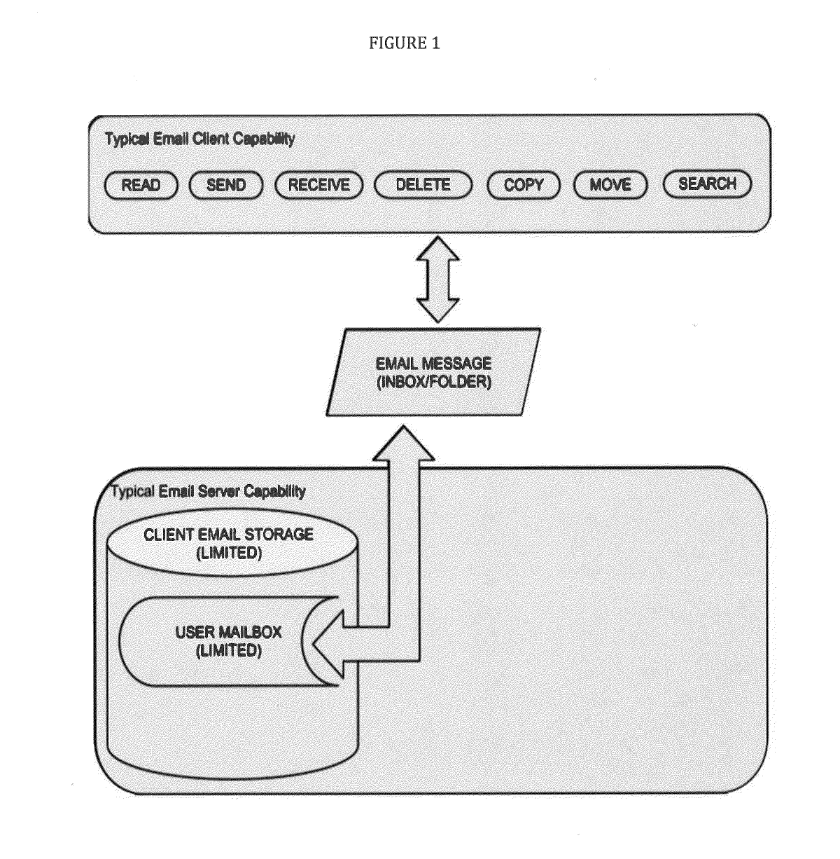

Turning to FIG. 1, a layout of typical capabilities of a conventional email client with email services is illustrated. The top box illustrates the email client's capabilities in regards to a user's personal email. A user can read, send, receive, delete, copy, e.g., between folders, move, e.g., from one folder to another, and search email messages. These interactions with email messages on the email client are, simply put, actions initiated on the email server that contains the user's INBOX or other folders and then synced to the applicable email clients. In this manner, an action performed on a user's email account, for example, using an email client configured for use with a smart phone, is reflected when accessing the same user account on a work or home computer email client. The bottom box illustrates an email server with the user's current mailbox. These email servers typically have limited storage capabilities and their performance in providing email in a timely manner tends to suffer dramatically if too much email is stored.

Typical email clients have various capabilities including read, send, receive, search, and delete email messages, as well as copy, move delete, and sync with folders. In a standard email client configuration, a user would have a main inbox and a sent items folder. The user may or may not organize messages into a variety of other folders. Email clients will typically sync messages from whatever folders a user has subscribed to. Syncing is the process in which the email client and email server first determine what messages have not been sent to the email client and then second sends the non-existing messages to the email client. After syncing any new messages for the user should exist on both the email client and the email server. The email client may or may not copy the entire message. The client may not copy an entire message because in certain cases the email client may just request the bare minimum to display the email message in a list. If this is a case and the user finally decides to read a message, the email client will pull the full message data from the server.

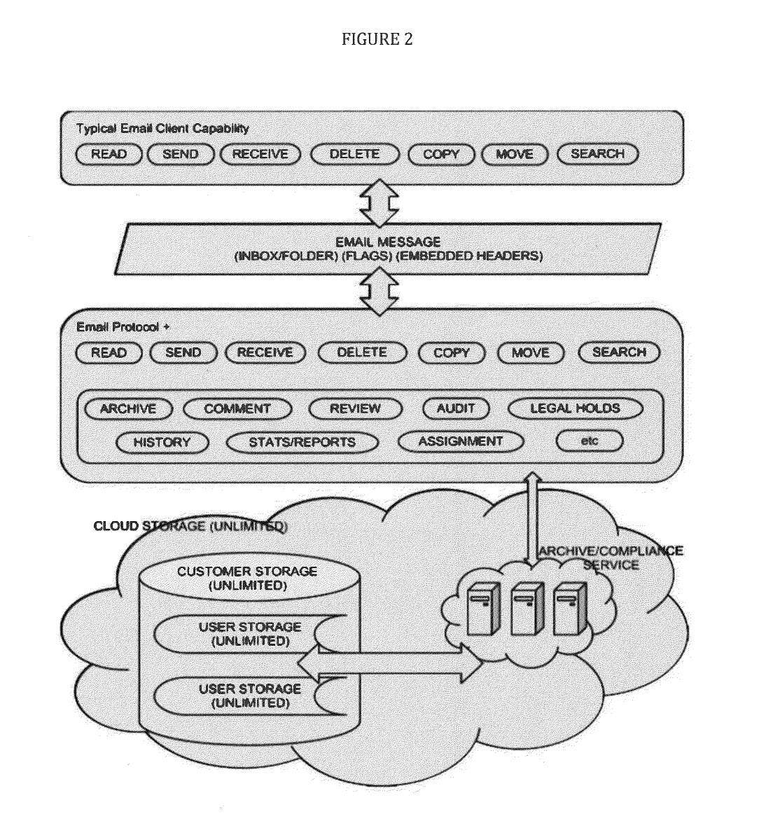

FIG. 2 illustrates capabilities of an email client with functions provided by an exemplary embodiment of the system and method of the present inventive concept, which is illustrated as a layer between an email client and a service that is not a normal email service, e.g., a cloud-based service.

In FIG. 2, the top box represents capabilities of an email client in communication with another service, e.g., an archive service or a compliance service, having a layer representing the protocol expander of the present inventive concept therebetween. The user is provided with email client capabilities, e.g., read, send, receive, delete, copy, move, and/or search email messages. Additionally, by combining email messages with folders, flags, and/or other headers, the protocol examiner advantageously provides additional capabilities, e.g., comment, review, legal holds, and/or assignment. Adding these other capabilities is done by interpreting or overloading standard instructions by the email client such as, but not limited to, a command to flag one or more emails or the like, and combining these instructions from the client with the context of what the instructions apply to on the server such as, but not limited to, a structure of folders and other attributes.

This combination of standard email client instructions and the context of the object they apply to provides numerous applications to occur, thereby enhancing business operations and email compliance monitoring, tracking, and/or reporting. These practices can be applied to messages that also represent other electronic communications, e.g., faxes and/or social media communications. The bottom cloud-like image represents a service, e.g., an archive or compliance service, configured to handle large storage of electronic communications without suffering from the aforementioned performance degradations of conventional email servers when handling large storage.

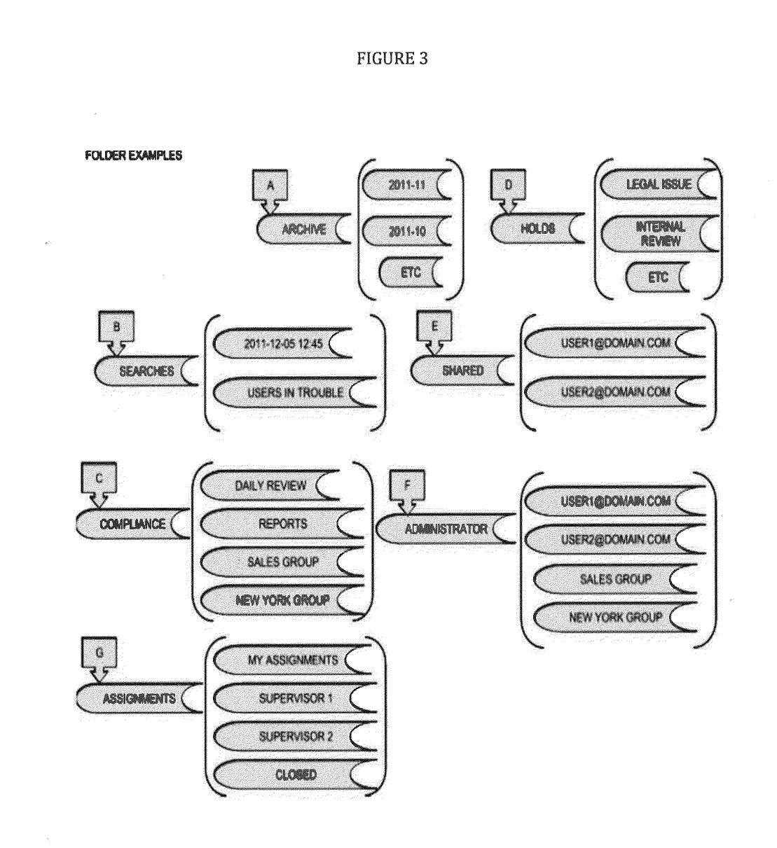

FIG. 3 is a layout of folders provided by a protocol expander of the present inventive concept. References “A” through “G” relate to Example A through Example G, as described hereafter. The protocol expander is configured to communicate between the email client and one or more other services. The protocol expander takes capabilities, e.g., of the email client, and overrides them by combining folder paths with one or more actions taken on the folder or any given email message in the folder. Usage of headers and/or flags will further provide information for providing the new capabilities. FIG. 3 provides a sampling of folders and subfolders that can be provided by the email protocol expander. The new capabilities are explained further hereafter.

Example A represents a user's complete historical email and other electronic communications archive broken up into year/month folders. By viewing year/month folder the user would be able to view all the messages for that year/month.

Example B represents a user's history of saved searches done on an archive or compliance service. A saved search would be a search for messages with the results saved to the system under a unique name of some kind. By viewing a saved search folder, the user is able to view all the messages for that saved search using the protocol expander of the present inventive concept.

In an embodiment, both examples A and B initially start out with a single command message. The command message may provide multiple ways to command the protocol expander to allow the user to synchronize all messages in a folder.

Example C represents an example set of folders that exist for a compliance person using an email client to access a compliance service through the email protocol expander. The compliance person typically has to review a certain amount of communications a day. With the protocol expander, the compliance person can perform this daily review through a preferred email client. In an embodiment, the email client can be used to access and manipulate a variety of messages.

In alternate embodiments, other types of client software could be used. A daily review folder can contain a set of messages based on the user's or the user's organization's settings for the day. By reading each and every message in this folder, the user is able to fulfill the daily compliance requirements. The email client is configured to update the protocol expander that certain messages have been read by the user. This update of reviewed messages occurs over the standard mail protocol indicating that a particular email message has been read. By combining the context of the message on the server, the instructions from the email client, the protocol expander is configured to interpret or label a particular email as reviewed. In this manner, the user is able to demonstrate that they have fulfilled their business requirement. The compliance service retains an audit trail of the messages reviewed by the user. A reports folder contains messages generated by the compliance service to update the user on his statistics or possibly the statistics of his team or employees. The service might also provide folders that represent either all or a generated set of messages of a group of users that this compliance person has been given access to. That folder might be broken down even further to more child folders that represent each user within a group or a breakdown by date/time of the group.

Example D represents an example set of folders for an administrator or compliance person that has been given the capability to put electronic communications on legal hold. A legal hold is essentially a rule put on a set of email messages to be never deleted from an archive or compliance system during a legal investigation. By having folders represent legal holds, the administrator or compliance person can copy communications from non-legal holds folder into the legal holds folders to ensure that they are never deleted from the service. These is an example of how a compliance or business function could be carried out via a typical email client, but due to the context of the folder and settings, enable a much richer set of functionality like legal holds for a set of email. It is foreseen that this setting may be turned on and configured via specifically crafted email messages known as control messages that instruct the server what to do and/or how to do it.

Example E represents a set of folders configured to provide shared mailboxes. On email servers and archive services a mailbox of a first user is shared with a second user. In other words the first user can be given permission to view the messages of the second user. Using the protocol expander, any other user's mailboxes can be represented as a folder. Child folders may be configured to breakdown the user's mailboxes into smaller date folders and/or may display other folders relevant to the user. This functionality of the present inventive concept allows for a better and more intuitive method for sharing email data by allowing the user to control how it is displayed in their email client and in a more ordered fashion.

Example F represents an example set of folders that an administrator might see on an archive service. The administrator may have access to one or more users represented by folders via the system and method of the present inventive concept. An administrator may also have access to a group of users as well. These folders may also contain children folders that are configured to breakdown messages into smaller date folders or may display other folders relevant to the users or groups. This functionality allows better navigation and easier ability to sort and possibly review the large sets of data that might be produced by a given organization. The access, configuration, and caching of this large dataset can further be configured through the use of control messages. These control messages help overcome any limitation that may be on the email client and hamper the ability to interact with large data sets or an extremely large email corpus.

Example G represents an example set of folders for assignments. A compliance person may be working with a team of compliance people. During his review he may come upon a message that he needs to discuss with another person on his team. In such a scenario, the compliance person can copy a message from the folder in which it was originally found to a child folder under assignments that represents the other compliance person. This will allow the other individual, e.g., to whom the child folder was assigned, to have immediate access to the email within that folder if they have configured their email client to interact with the service. When that person logs on to the compliance service through a protocol expander or on the website of the compliance service, the protocol examiner presents any message assigned to that person.

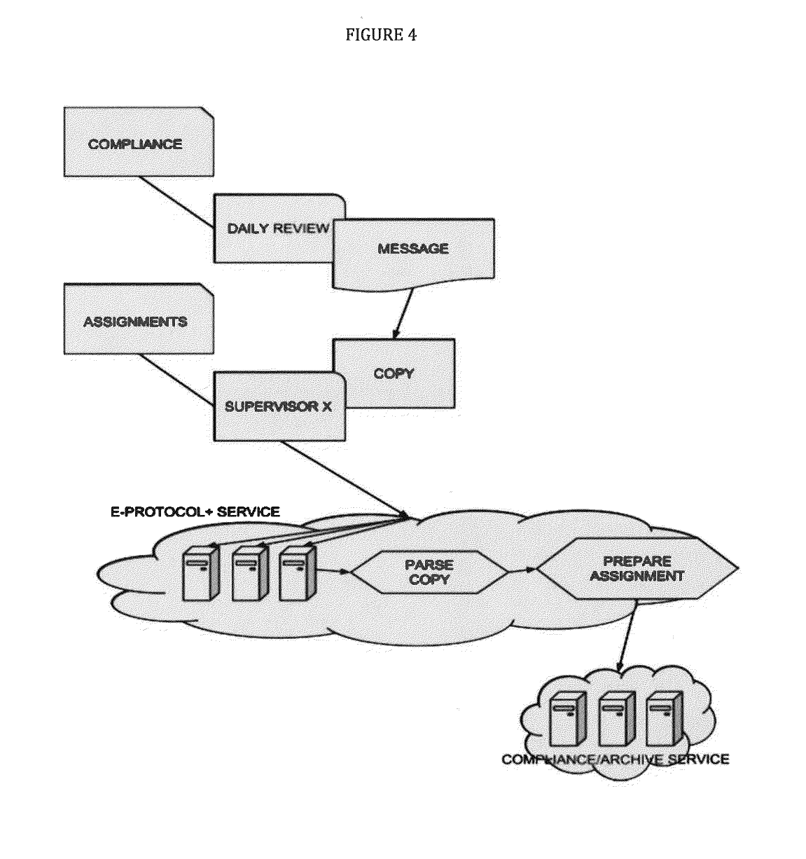

FIG. 4 is a flowchart example of performing an assignment using the copy action. Folder actions such as copy, move, and/or delete may be used in conjunction with message headers as workflow mechanism using the system and method of the present inventive concept. An example workflow includes handling one or more assignments. The action of taking an email message and moving or copying it from a folder representing one user, e.g., as illustrated in FIG. 3 (“G”) and FIG. 4, to another will act as assigning the email message from one user to another. As displayed in FIG. 4, the user is allowed to copy a message from one folder, for example, a daily-review folder, and copy it to, for example, a supervisor's folder, using the system and method of the present inventive concept. This copy is interpreted by the protocol expander as an assignment command. The assignment happens in the underlying compliance service. Another example would be putting messages on hold by taking a message from any folder and copying it to any folder under the holds folder.

In this example illustrated by FIG. 4, a compliance person identifies a message in his daily review folder with possibly questionable content that could violate the organization email policy. The compliance person is able to copy the message into another folder, e.g., a supervisor's folder, for further review. When this action takes place, the email client communicates the action to the compliance service through the email protocol expander. The protocol expander is configured to interpret any commands given by the regular or normal email client by combining the email protocol instructions with the context that may exist for that user, data, and/or location, and instruct the underlying compliance service that the action of copying a message from the daily review folder to the supervisors folder that is a child folder of assignments is actually supposed to be an action on the compliance server to assign the message to the supervisor.

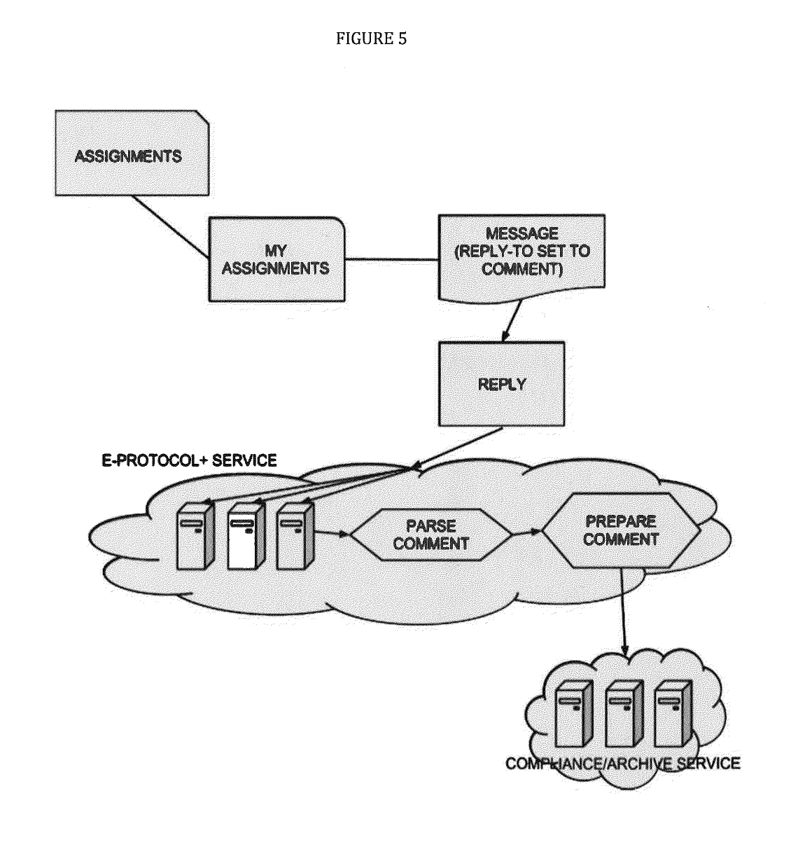

FIG. 5 is a flowchart illustrating how a comment action can be implemented using the reply action. Certain folders will override the reply-to header in email messages to change any replies to an email message into an action message. The action message indicates to the service that some action will need to be taken on this message and potentially enable other events in the review compliance workflow. An example includes replying to an assigned message. Replying to a message in a folder representing a user's assignment modifies the reply message to a comment action. FIG. 5 illustrates how the reply flows through a protocol expander and becomes a comment action. The user replies to any message in his my assignments folder. The reply-to for the message will be pre-set to an email address specifically for an email protocol expander. When a protocol expander receives the message, it is parsed for message information and the reply will become the comment. The comment will be stored in the service providing the assignments folders. Another example of a reply-to as an action is replying to a message in a folder representing social media such as those systems provided under the trademarks TWITTER® and/or FACEBOOK®. In this case, doing a reply is akin to posting an update to such systems.

In this example, a compliance person is in his my assignments folder. After viewing a message, the compliance person may add a comment to the message by simply replying to the message. Normally, when replying to a message, the to address is the original message's from address. However, the protocol expander ensures that the reply-to header, which can specify the to field on a reply, with a specific address, e.g., determined by the protocol expander, that upon receipt of the reply, automatically parses out the reply message and prepares it to be a comment action entered into the compliance service.

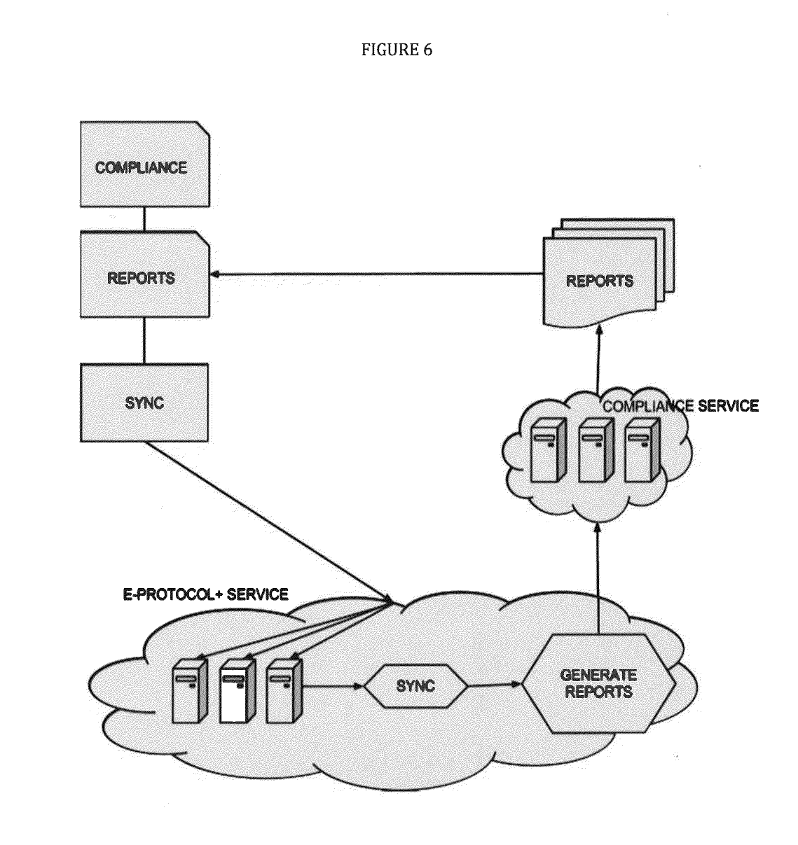

FIG. 6 illustrates a flowchart example of performing a retrieve reports using a sync action. As illustrates, a compliance person accesses a reports folder. The email client of the compliance person, behaving in a normal fashion, attempts to sync this folder from the service to the email client to pull current email that may have arrived during a given time period. This periodic polling of the email service is a typical process for the email client. In an embodiment of the present inventive concept, this action is interpreted by the protocol expander as a signal to the underlying compliance service to generate one or more reports. In this manner, when the folder is synced again, new reports appear as messages in this folder.

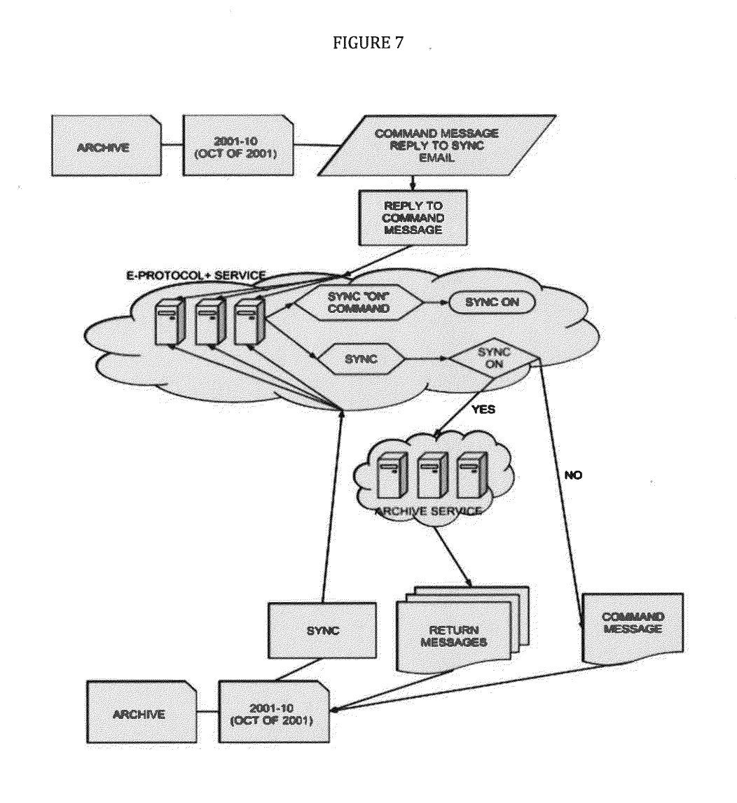

FIG. 7 is a flowchart exemplifying a sync enabled by command message for historical messages. When the user first accesses the user's historical email that is broken up into year and/or month folders, the user will initially have a command message in each folder. This initial command message is placed within the folder as a placeholder, which allows the service to overcome the limitations of many email clients when dealing with large data sets. In an embodiment, the control message indicates to the user that data is present, allows an easy way to provide the user easy access to the data, and prevents the email client software from impacting the user experience as most email clients cannot cope with large sets of email such as a set that spans several years. The command message will offer several “commands” that allow the user to configure his folder. These control messages will allow the user to interact with the server through these commands by simply having the user send the messages as normal email to a specific email address, carrying out the desired commands by the user. Some sample commands can include sync, unsync, and/or resync. The user can send a command to the protocol expander through a form on the command message, a link to a form on a protocol expander website, and/or by including the command in a reply. FIG. 7 illustrates a process that allows a user, using an exemplary embodiment of the present invention, to sync and/or unsync by replying to the command message. When a user replies with a sync command, the protocol expander receives the reply, parses out the SYNC command from the reply, and communicates with the underlying archive service to allow the user to view all messages in that folder. When a user replies with the unsync command, the protocol expander receives the reply, parses out the unsync command from the reply, and communicates with the underlying archive service to not allow the user to view all messages other than the command message.

It is foreseen that command messages can be used to provide configuration to the services. An example would be a command message to enable the syncing of a particular historical email folder. FIG. 6 illustrates how a default view of an archive folder of a specific date range that would display no messages other than a command message. By replying to the command message, the user requests that all messages for that month and/or year be made available to be synced. The command message is sent to the protocol expander, which updates the underlying archive service of the user to now allow syncing of message for that date range. When the email client requests a sync of the folder, it will get all messages for that date range, i.e., the date range specified by the user.

It is foreseen that when certain folders are synced, such will cause processes on the service to generate new content for the certain folder. An example would be syncing a statistics or reports folder. FIG. 7 illustrates that, when the email client syncs the reports folder, the protocol expander requests that the archive or compliance service generate one or more messages to be synced to the reports folder, e.g., folders that are unique to the user. Another example is syncing a compliance daily review folder to generate enough messages to fulfill the user's daily compliance requirements.

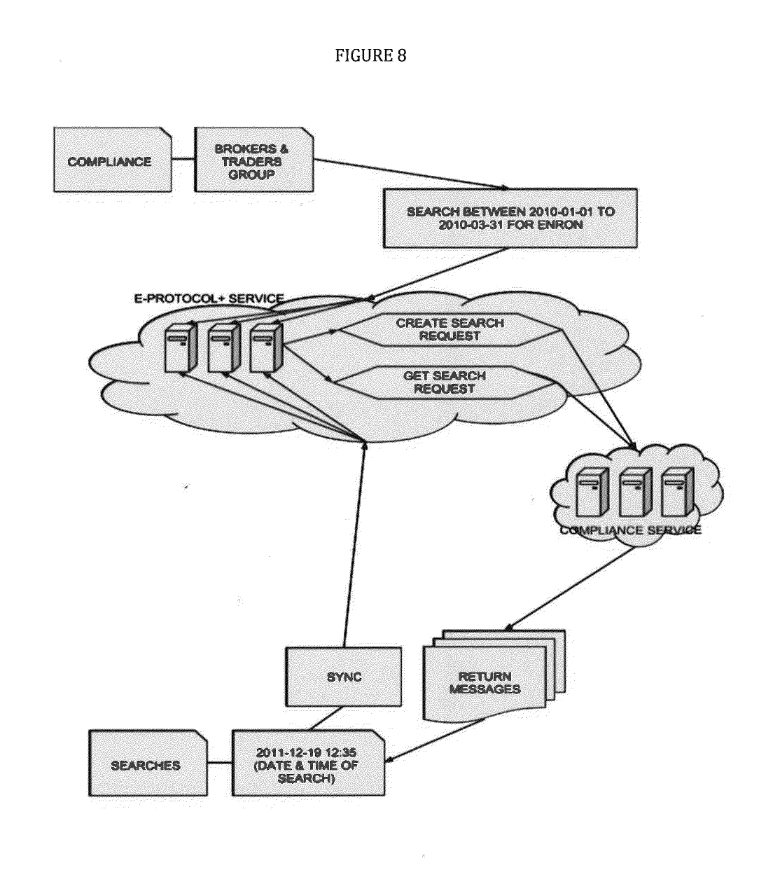

FIG. 8 is a flowchart illustrating an example of performing a search. Traditional email clients provide an ability to search for messages locally on the user's folders that have messages cached on the email client. Such traditional email clients also offer the ability to search for messages on the server. In an embodiment of the present inventive concept, such capability can be extended to not only search the user's own personal archive of messages but also search other users' archives based on administrative and/or compliance permissions, and then for the results to be saved to a saved-search folder as further discussed hereafter. FIG. 8 illustrates a flowchart of a user performing a compliance search against a certain group of users called brokers and traders. The search runs and the results of the search are provided to the user. Because the user has instructed the email client to perform the search on the server, the protocol expander server interprets this command to perform the search in the background and prompts the underlying compliance service via network API to save the results to a saved search folder. This saved search folder is added to the folder tree on the user's email client and contains the results of the search. The user can view these results at any time by going to the saved search folder and running a sync command on that folder. This functionality allows the user to not be impeded by lengthy and long searches that may consume significant resources on their email client, provides a structured format for displaying search results, and allows the returned search set to be easily retained for future reference. When the user no longer wishes to have the search result folder displayed within their email client, they simply have to delete the folder on the client and server will interpret this as not needing to provide this folder for that particular user in the future, however the email contained within the folder will not be deleted from the server.

Searches against certain folders will generate new search folders that contain new content previously unavailable to the user due to email client limitations. An example would be running a search against a compliance folder for a group of users. FIG. 8 illustrates how a search request generates a new search folder with messages matching the search. The user requests a search with specific parameters against a folder representing a group of users. The search requests goes to a protocol expander which then sends the request to the underlying compliance service. When the search completes the compliance service will have a new search folder with the results of the search in the search folder. The name of the folder is based on the date and time of the search request. A notification email will also get sent to the user which will appear in the user's INBOX. When the email client syncs the new search folder, the messages for the search will be sent to the email client.

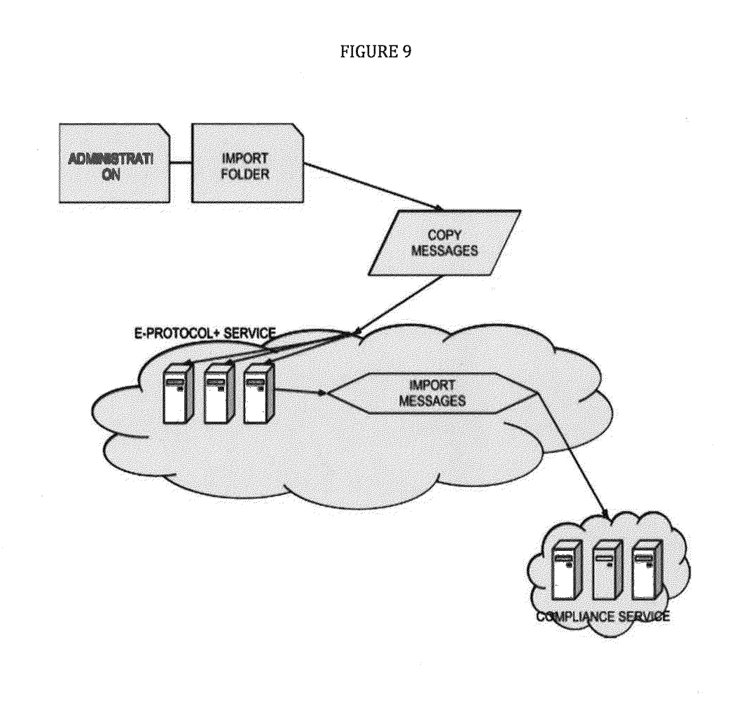

FIG. 9 is a flowchart illustrating importing messages, A user with administrative rights can have a folder or folders that can act as an import repository on top of a compliance or archive service. FIG. 9 is a flowchart example of such a user copying messages from an outside source, e.g., another email account, a local data folder provided by a system such as that made available under the trademark MICROSOFT OUTLOOK®, into an import folder. The protocol expander interprets this action as an action to import these messages into the underlying compliance or archive service.

For Compliance and Administrative purposes, any messages that are viewed by the email client will generate an audit trail recording that messages have been read by someone with access via compliance or administrative permissions.

Those skilled in the art understand that the preferred embodiments described above may be subjected to apparent modifications without departing from the true scope and spirit of the invention. The inventors, accordingly, hereby state their intention to rely upon the Doctrine of Equivalents, in order to protect their full rights in the invention.

The protocol expander is configured to cooperate with existing digital media client software and protocols, e.g., an email client, to enable intuitive and efficient business operations to take place. Such is accomplished by having server-side components configured to operate with existing APIs, interpret standard protocol communications in an original fashion by combining these standard protocol operations with additional context like user identification, user access rights, attributes of the digital object that the commands are operating on, and/or through the use of command messages that allow users to significantly expand the capabilities of traditional client software as well as overcome the limitations of said software. The introduction of these capabilities allows for significant advancement in business operations and productivity that can be accomplished through a traditional software client like an email client. The basic methodology that would enable a user to interact or attain these increased capabilities would involve the user configuring a software client to connect to the protocol expander service. Once this is done, depending on what the service is configured to provide for that user, the user would be able to carry out interactive workflow business operations like email compliance review or be able to access and search large sets of data that is not stored on the user's local machine. All of this would be done without installing additional software on the user's machine, and enable the user to have access to this significant improvement in functionality across most modern software clients.

In this manner, the present inventive concept provides a protocol expander system and method operable to provide expanded capabilities for handling of electronic communications and documents including, for instance, by expanding capabilities of email-access software by incorporating an expanded email protocol layer between an email client and one or more electronic communications and/or document services.

The previous description of the presently disclosed inventive concept is provided to enable any person skilled in the art to make or use the present inventive concept. Various modifications will be readily apparent to those skilled in the art, and the generic principles defined herein may be applied alternatively without departing from the spirit or scope of the present inventive concept. Thus, the present inventive concept is not intended to be limited to the description herein but is to be accorded the widest scope consistent with the principles and novel features disclosed herein.

The steps of a method, system, or operation described in connection with the present inventive concept disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

Having now described the features, discoveries and principles of the present inventive aspect of this disclosure, the manner in which the present inventive aspect is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the present inventive aspect herein described, and all statements of the scope of the present inventive aspect which, as a matter of language, might be said to fall there between.

What is claimed is:

1. A method to provide control over a communication system, implemented at least in part by a computing device, said method comprising the steps of:
creating one or more administrative folders;
inserting at least one control message in the one or more administrative folders;
determining if a user has a compliance role;
allowing at least one compliance action to occur if the user is determined to have the compliance role; and
facilitating at least one administrative action on a message in the communication system.

2. The method of claim 1, wherein the communication is an email communication.

3. The method of claim 1, wherein the at least one control message is configured to cause at least one default action to occur on the one or more administrative folders.

4. The method of claim 1, wherein the compliance role determination is performed during a login operation.

5. The method of claim 1, wherein the facilitating of the at least one administrative action on the message in the communication is performed when the user issues a command to the computing device.

6. The method of claim 1, wherein the at least one administrative action is a compliance action.

7. A system to provide control over a communication, said system comprising:
one or more administrative folders;
at least one control message configured to be inserted in one or more of the administrative folders; and
a processor configured to determine if a user has a compliance role,
wherein,
the processor is configured to (i) allow at least one compliance action to occur if the user is determined to have the compliance role, and (ii) facilitate at least one administrative action on a message in the communication system.

8. The system of claim 7, wherein the communication is an email communication.

9. The system of claim 7, wherein the at least one control message is configured to cause at least one default action to occur on the one or more administrative folders.

10. The system of claim 7, wherein the compliance role determination is performed during a login operation.

11. The system of claim 7, wherein the facilitating of the at least one administrative action on the message in the communication is performed when the user issues a command to the computing device.

12. The system of claim 7, wherein the at least one administrative action is a compliance action.
